(19) United States
(12) Patent Application Publication
(10) Pub. No.: US 2015/0348188 A1
(43) Pub. Date: Dec. 3, 2015

(54) System and Method for Seamless Integration of Trading Services with Diverse Social Network Services

(71) Applicant: Martin Chen, Irvine, CA (US)

(72) Inventor: Martin Chen, Irvine, CA (US)

(21) Appl. No.: 14/287,739

(22) Filed: May 27, 2014

(51) Int. Cl. G06Q 40/04; G06Q 30/02

(52) U.S. Cl. CPC G06Q 40/04; G06Q 30/0201

(57) ABSTRACT

A method for enabling interaction between users on a trading platform includes assigning a credit score to each user based on the user's action and also based on the actions from other users and on the market condition. The users may form social circles based on their interests and the trading system will present postings from other users and the market information to the user according to the information and action taken by the user.

### FIELD OF THE INVENTION

The present invention generally relates to data processing and more specifically to a system and method for processing information from different platforms.

### BACKGROUND OF THE INVENTION

Social networking websites are staples in our lives. Everyone is part of one or more social networking websites and each person uses each social networking for different purposes. On one website, a person may share his gardening interests and on another side the person may share his memories of college life with his former schoolmates. Still, the person may use yet another website to generate income for his living.

Generally the networking websites are independent from each other; however the information that one person posts one website may be related to a posting by him on a different website. Unless active steps are taken by that person, his postings on one website will have no impact on his postings on another website. So, potentially he can have one personality on a professional networking website and a totally different personality on a dating website.

Now, the reputation of a user on one website may be affected by his actions on another website. The actions by the user on one website may have a positive impact or a negative impact on the reputation of the user but this impact remains large unknown to other users unless a comprehensive search is done over the Internet. This situation may be a problem if the user is an expert in one area and provides information to other users. The reputation of this expert is very important to other users who rely on the information this expert provides and the other users would benefit by knowing what actions this expert has taken that would affect his reputation.

Therefore, it is to a system that enables this information flow from different websites and also enables users to make assessment of the information received from different experts on the Internet the present invention is primarily directed.

### SUMMARY OF THE INVENTION

The present invention has been made to overcome the aforementioned disadvantages of conventional methods. In one embodiment, the present invention is a method for rating the credibility of an online expert. The method comprises collecting, by a trading information smart matching unit, postings by the online expert on a trading system, collecting, by the trading information smart matching unit, information related to the postings from public sources and social networking websites, and calculating, by the trading information smart matching unit, a rating by comparing the information related to the postings with the postings.

In an alternative embodiment, present invention is a method for providing financial information related to a stock to a user. The method comprises collecting, by a trading information smart matching unit on information posted by acquaintances of the user on at least social networking website, social-based information related to the stock, assigning, by the trading information smart matching unit, a weight to each collected social-based information, collecting, by the trading information smart matching unit on public sources, public information related to the stock, assigning, by the trading information smart matching unit, a weight to each collected public information, and presenting, by the trading information smart matching unit, hierarchically the collected social-based information and the collected public information to the user according to respective assigned weights.

In yet another alternative embodiment, present invention is a method for calculating a credit score of a user by a trading system. The method comprises assigning, by a trading information smart matching unit, a first static score for each posting posted by the user, assigning, by the trading information smart matching unit, a second static score for each positive feedback received by each posting posted by the user, assigning, by the trading information smart matching unit, a negative score for each posting removed by the user, assigning, by the trading information smart matching unit, a first variable score for each posting with a relevant subject matter posted by the user, assigning, by the trading information smart matching unit, a second variable score for each posting posted timely by the user, and determining the credit score by adding up scores assigned to the postings posted by the user.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 is a schematic 100 depicting the function of the present invention;

FIG. 2 illustrates a block diagram 200 illustrating the relationship between a system according to the present invention and different websites and a trading system;

FIG. 3 illustrates a process 300 of transferring information from a social networking domain to a trading service domain;

FIG. 4 illustrates a process 400 of transferring information from a trading service domain to a social networking domain;

FIG. 5 illustrates illustrating a process 500 for collecting information on a social networking website;

FIG. 6 is a flowchart 600 illustrating a process for collecting information on a trading website;

FIG. 7 is a diagram illustrating a strategy recommendation process by the trading system;

FIG. 8 is a diagram illustrating a process for setting up strategies; and

FIG. 9 is a block diagram of an apparatus according to the present invention.

### DETAILED DESCRIPTION OF THE PREFERRED EMBODIMENTS

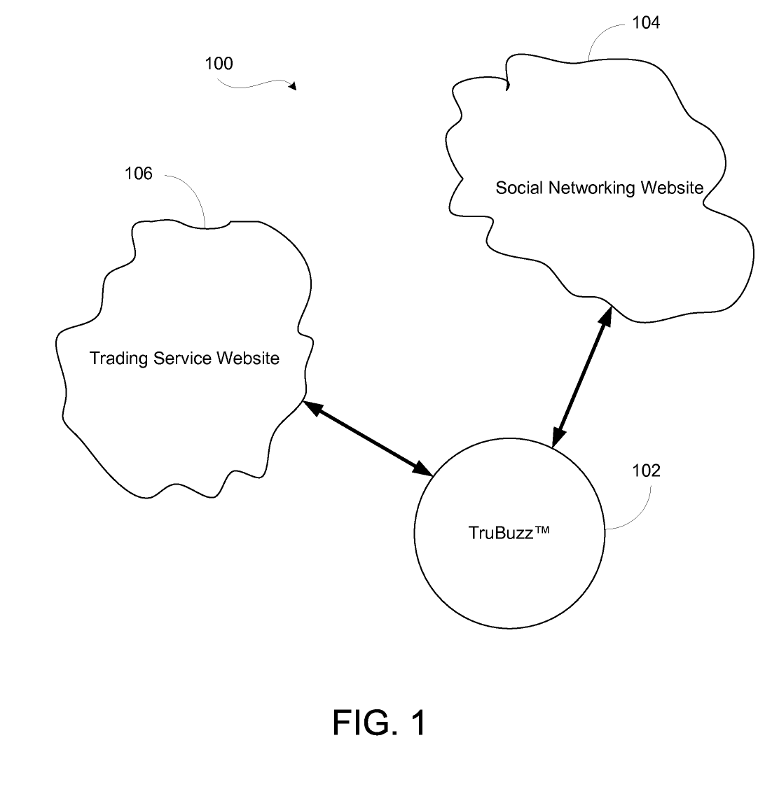

Because of proliferation of the Internet, it is common for a user to connect to his friends and family members through a social network website and also to manage his stock holdings through a trading website. FIG. 1 illustrates a schematic 100 that shows a trading system 102 according to the present invention interfacing with a social networking website 104 and a trading service website 106. The trading system 102 of the present invention enables a user to easily navigate between two different systems (websites) and the information posted in one system is made available to other system. A typical trading system is a software program running on a computing device (PC or Tablet alike) and allows users to study securities, manage own portfolio, and submit trading orders among other things. In most cases, a typical trading system is a standalone system with a single user application scenario. The trading system 102 of the present invention seamlessly integrates functions of a typical trading system with diverse social network service platforms, allows trading system users to integrate their own social network services.

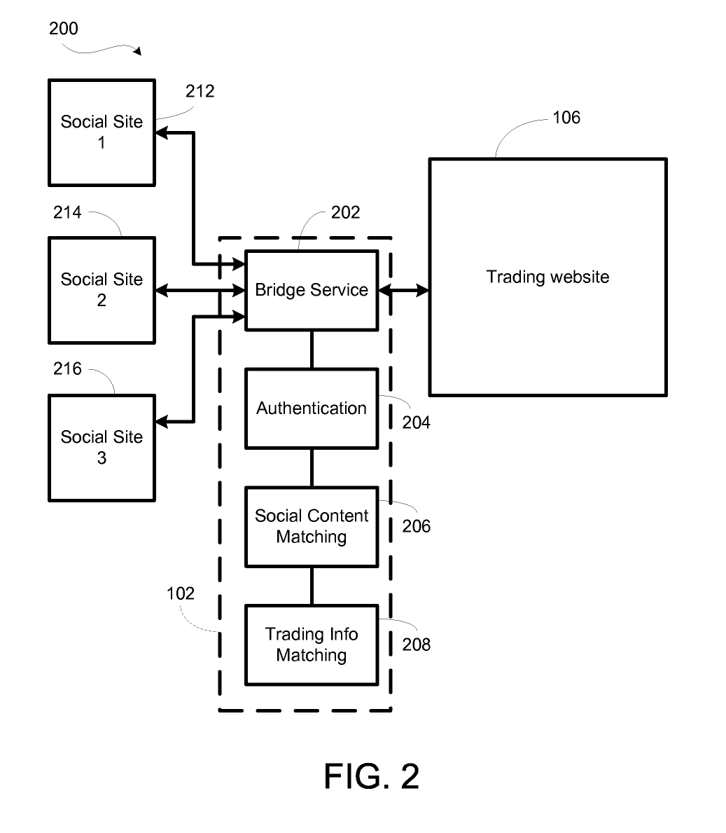

FIG. 2 illustrates a block diagram 200 that illustrates the relationship between the trading system 102 and the trading service website 106 and different social networking websites. One user may be registered with several social network websites 212, 214, 216, such as Facebook™, Twitter™, Linkedin™, etc. and the trading system 102 of the present invention enables the user to access any of the social network websites and also the trading service website 106 through which the user may perform financial transactions. The trading system 102 include four modules: bridge service module 202, authentication module 204, social content matching module 206, and trading information matching unit 208. The trading system 102 provides several services, such as user authentication by the authentication module 204, screening of social contents by the social content matching module 206, screening of trading information by the trading information matching module 206, and information transferring between the social networking websites and the trading system 104 by the bridge service module 202.

The trading system 102 allows users to login using their existing account name and password from any one of their social network services. Through the authentication module 204, the trading system 102 links to the social network service websites through the standard API provided by these social network service websites. Only after the successful linkage and authorization from the social network services is established, the user could login to the trading system 102 successfully. After the user is logged in, the trading system 102 loads the user's profile information, including the friend list, the most recent posts, and other related authorization information, and the user can start using this information for real-time on-line interactions.

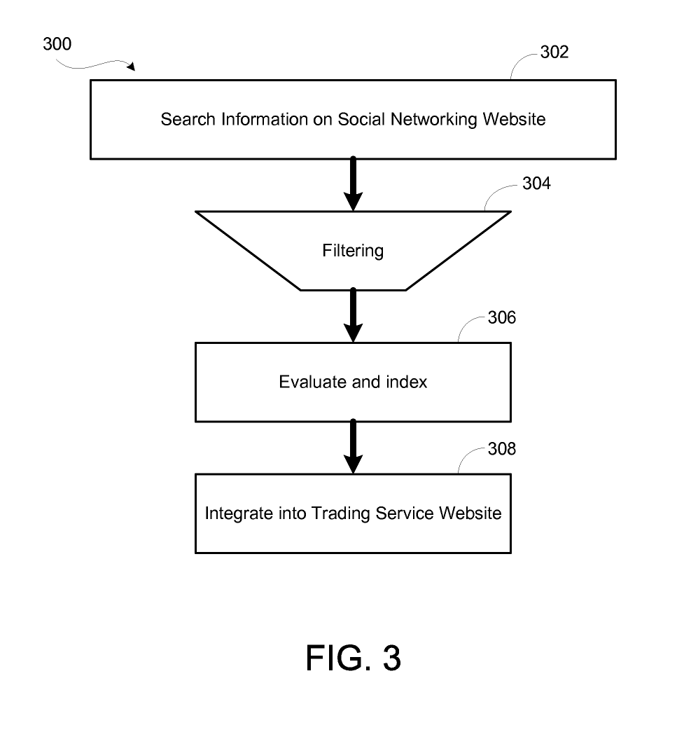

FIG. 3 illustrates a process 300 of transferring information from a social networking website to a trading service website performed by the trading system 102. A user may share his financial activities with his friends by posting his financial activities on the social networking website and these activities may be of interest for other users on the trading service website. The social content matching module 206 searches information related to financial activities of any and all users on a social network website, step 302, and filters the collected information, step 304. The filtering criteria includes, but not limited to the fully matched stock name, stock symbol, company name, company news, stock price, published financial information, and any related wording, etc. The filtered information is indexed, step 306, and the indexed information is integrated into the trading service website, step 308.

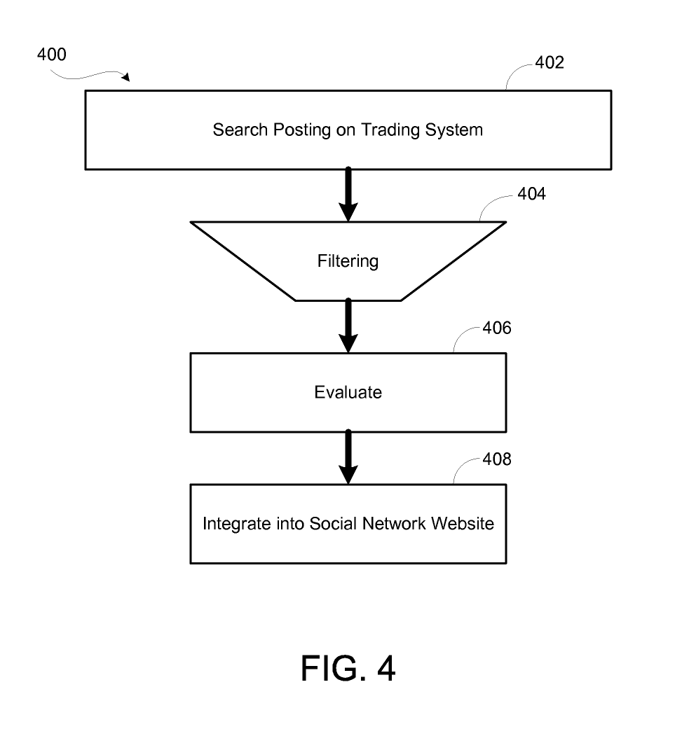

FIG. 4 illustrates a process 400 of transferring information from a trading service website to a social networking website. The trading system 102 collects financial related information from different news media and posts this information on the trading system 102. The social content matching module 206 searches the financial information posted by the trading system 102, step 402, and filters the collected information, step 404. The filtering criteria includes, but not limited to the stock name, the trading symbol of the stock, the company name, the news related to the company, the stock price, the published financial information, and any related wording, etc. The filtered information is indexed, step 406, and the indexed information is integrated into the social network website, step 408.

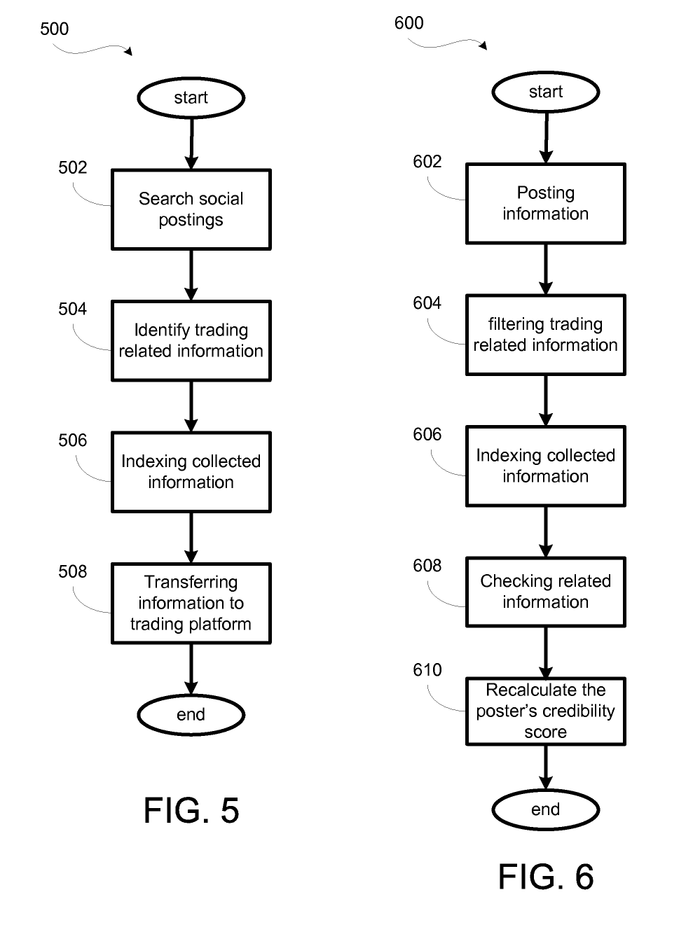

Often people share events that happen in their lives and their activities with friends and acquaintances by using the social networking websites and many of these activities relate to their financial activities. By collecting and analyzing how people invest their money, a trend can be detected and valuable financial information can be derived. FIG. 5 is a flowchart illustrating a process 500 for collecting information on a social networking website. The system administrator of the trading system 102 can set criteria for searching social postings on the social networking website, step 502. The searching criteria may be stock name, stock symbol, company name, company news, stock price, published financial information, and any related wording as described in FIG. 3. After the information is collected, the information is filtered, step 504, to remove non-financial information. For example, a posting with “iPad” and “stock” may be collected but the posting may be “after buying an iPad, I wish I had bought Apple stock.” This posting has no particular financial interest, so it will be filtered out. The filtering or identification of trading related information may be based on key words and verbs.

F(filter)=F(keywords)×F(verbs)

After filtering the collected information, the filtered information will be indexed, step 506, and transferred to the trading system 102, step 508. The indexed information may or may not be associated with the identity of the person who posted it. If the person who posted it has also an account on the trading system 102 or is someone who poses himself or herself as an expert in the trading system 102, then the indexed information will be associated with this person.

The process 500 will also be performed over postings from the trading system 102 on the social networking website. The trading system 102 may have a profile on the social networking website for interacting with its users. As part of interacting and serving its users, the trading system 102 may post financial information on the social networking website and each posting may receive follow-up comments from the users on the social networking website. The follow-up comments from the users are collected, analyzed, indexed, and send to the trading system 102.

The trading system 102 allows a user to post any information on a special designated interface and the trading system 102 will send this posted information to any social networking website pre-authorized by the user. Alternatively, the user can authorize the trading system 102 to send the posting information to other websites that the trading system 102 has a special relationship.

The trading system 102 allows a user to directly interface with the stock exchanges. The user can, through the trading system 102, directly place transaction orders, such as buy or sell orders, with the stock exchanges and can also manage his portfolio. The trading system 102 can access, with the user's authorization, the user's transaction data on these stock exchanges. The user may also maintain a blog to record his activities, thoughts, or anything else and the user can make this blog accessible to every user, or only a subset of the users, on the trading system 102. The user can provide his suggestions for stock purchasing or comments on the recent financial policies adopted by the government. The user's postings may receive feedback from the other users.

The user's reputation is affected by the feedback from the other users. Each user who posts information on the trading system 102 is given a “score.” If many users follow this user's advices or suggestions and the users give a “thumb up” (or other positive feedback indicator) to this user, then the score for this user will be raised. The score of the user may also be impacted by the user's own action. For example, if the user recommends a stock on company AAA but privately he has liquidated his holding on company AAA, the score for him may be negatively impacted.

FIG. 6 is a process 600 for handling a user's postings on the trading system 102. The user, who may be an online expert, may post financial related information on the trading system 102, step 602. The trading system 102 will filter the posted information, step 604, and index the posted information, step 606. After the posted information is properly classified, the trading system 102 will check for other related information, step 608, and recalculate the poster's credibility score, step 610. The related information may include news and other public information related to the posted information and may also include ratings he received from different professional associations or feedbacks he received from his readers. A user's credibility score is frequently adjusted and the calculation depends on the user's activities and also the comparison between the current financial condition and the user's prediction. For example, if user posted a suggestion for buying stocks from company BBB and he bought a substantial quantity of the same stock, his action will have some positive impact on his score. Now, if few months later, the stock price for company BBB starts to rise, then the score for the user's credibility will be adjusted higher because the accuracy of his prediction. However, on the other hand, if the stock price of company BBB drops, then there will be a negative impact on the score.

The credibility score of the user may also depend on actions from other users. For example, if many users follow his advice, then his score will be adjusted higher. If he receives many positive feedbacks, his score will also be adjusted higher. If many people read his postings, his score will be adjusted higher. On the other hand, if very few people read his postings, then, his score will suffer negatively. The score is calculated as follows:

F(score)=F(accuracy of prediction)+F(poster's own action)+F(other user's actions)+F(market condition); (1)
accuracy of prediction—derived by comparing a poster's past prediction with the data collected since the s;
poster's own action—derived by checking a poster's action since the prediction;
other user's actions—derived by checking how many users have been influenced by the poster's prediction, how many feedbacks (positive/negative) the poster has received;
market condition—derived by comparing a poster's prediction with the market condition since the prediction;

The credit score of a user may also be determined the action taken by the user and also by knowledge learned by the trading system. For example, the credit score for the user may be composed of two components: (a) result of user's action and (b) assigned by the trading system. For each action taken by the user is assigned a score by the trading system. Below is a table with actions and corresponding scores assigned by the trading system.

TABLE 1

| Action | Score |
|---|---|
| Place a posting | S1 |
| Share a posting | S2 |
| Receive a Buzz | S3 |
| Give a Buzz | S4 |
| Remove a posting | S5 |

The table 1 illustrates few exemplary actions taken by a user and for each action a score is assigned. The scores S1 through S5 are static scores and predefined by the trading system for each action. For example, if the user writes (places) a posting about his view on a company AAA offering to purchase a company BBB, the trading system will add a score S1 to his credit score. If the user reads a posting by another and then forward (share) the posting to a friend in his social circle, the system will add a score S2 to his credit score. If one of his postings receives a “buzz” (positive feedback) from another user, then the trading system adds a score S3 to his credit score. If the user gives a “buzz” to another user's posting, the trading system will add a score S4 to his credit score. If the user decides to remove one of his postings, the trading system will add a score S5, which may be a negative score, to his credit score. Generally speaking, the trading system will add a score to the user's credit score if the user takes actions that promotes the use of the trading system.

The actions in Table 1 are intimately connected to the actions by a user. However, the trading system may also add scores to the user's credit score based on non-published criteria.

TABLE 2

| Criteria | Score |
|---|---|
| Subject-related | V1 |
| Subject-related-prompt | V2 |
| Well received by others | V3 |

Table 2 illustrates criteria that may be adopted by the trading system. For example, if the posting from the user concerns a relevant subject matter, the trading system adds a score V1 to the user's credit score. If the relevant posting is posted timely within a short time period when the relevant subject matter is still a “hot” topic, the trading system will add a score V2 to the user's credit score. If a posting of the user is widely viewed by other users, the trading system add a score V3 to the user's credit score. Scores V1, V2, and V3 are not static, which means that these scores is changed frequently by the trading system.

The trading system changes the Vn scores by checking postings and actions from the users of the trading system. For example, if the trading system detects that there is a significant increase in postings related to a merger of company X with company Y, this tells the trading system that this merger is a hot topic and the trading system will increase the score given to postings related to this merger. When the number of postings related to this merger drop, the score given to the postings related to this merger will also be decreased. Because of the dynamic nature of the postings by all the users, the scores given two different postings on the same topic may be different if the postings are done in different time. A timely posted posting will receive a higher score compared with the same posting posted a day later.

A user's credit score may also be impacted by his activities on the trading system 102, i.e., his interactions with information posted on the trading system 102. When a user reviews information on the trading system 102, he may leave his comments. For example, he may give a feedback on a particular stock by giving a “bear” sign or a “bull” sign, indicating his view on this particular stock. He may also share the information by sending the information or a link to the information to a friend in his circle; he may also leave a comment on the information posting itself, allowing everyone to see his writing. His every action has a positive impact on his credit score because every action indicates his participation in the trading system 102. On the same token, the frequency of his access to the trading system 102 is tracked, so is the time he spends on the trading system 102. The frequency and the length of the time he spends on the trading system 102 also have positive impact on his credit score.

The credit score calculation for the user may also be expressed according to the following equation.

F(score)=sum (static scores)+sum of (variable scores)+sum (system scores); (2)
static scores—scores that result from a user's action;
variable scores—scores changed by the trading system based on the postings from the users observed by the trading system;
system scores—scores reflecting a user's access to the trading system.

The trading system of the present invention enables a user to obtain useful information when making financial decisions. For example, when a user is using the trading system 102 to monitor a XYZ stock (or any financial instrument), the user may want to know whether his friends and acquaintances said about this XYZ stock or have purchased any XYZ stock. The user may initiate a request for information at the trading system 102. The trading system 102 will search and collect all the social-based postings regarding the XYZ stock posted by friends and acquaintances within the user's social circles. In this “circle based” indexing, each posting is weighted according criteria and the criteria may depend on poster's credibility and the relationship between the poster and the user. If a poster has frequent interactions with the user, then this social-based posting may have a higher weight.

The user may belong to more than one social circle and a very same news may be interpreted differently by people from different circles and also may cause people from different circles to react differently. The trading system 102 enables the user to receive information from different social circles.

Besides the circle based indexing, the user may also want to know what the market condition and trend is. For this “content based” indexing, the postings previously collected from the social network and also postings on the trading system 102 itself are searched, as well as public information related to these postings, are filtered based on the poster's credibility score and time of postings. Recent postings and public information will be more relevant than older postings. The postings from the circle based indexing and the content based indexing are presented to the user in a hierarchical order.

The information presented to the user by the trading system 102 is dynamic because the information is based on actual actions by different people making financial decisions and also based interactions between the user and his friends and acquaintances, while the traditional trading systems provide information based on the public information collected from different news media.

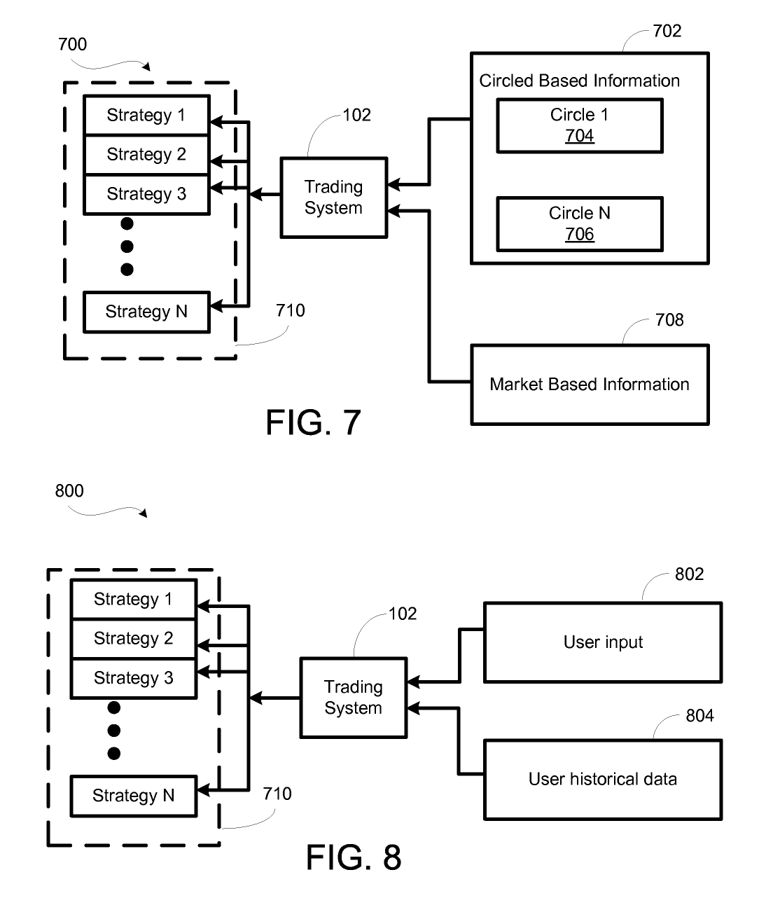

Besides providing information to the user, the trading system 102 is also capable of providing strategy suggestions to the user. FIG. 7 illustrates a process 700 for providing suggestions on strategy. When the user is making a financial decision, the trading system 102 uses the circle based information 702 (discussed above with the circle based indexing) and market based information 708 (discussed above with the content based indexing) and selects one strategy from a strategy archive 710 as the suggestion. The strategy selection process is illustrated as follows.

Strategy (score)=info (circle 1)+info (circle 2)+info (market); (3)
info (circle n) represent an index based on a selected number of high postings from the circle based indexing for circle n, n=1,
info (market) represent an index based on a selected number of high postings from the content based indexing.
Strategy(score) is a score (or a series of scores) for selecting a strategy from the strategy archive.

The strategies for making financial decisions can be devised based on the user's historical data and the user input. FIG. 8 illustrates a process 800 for devising financial strategies. The trading system 102 can take input from user 802 by asking the user a series of questions, such as his age, income, savings, years to retirement, risk level acceptance, etc. The trading system 102 can also analyze the user's past investment history. When analyzing the user's investment historical data, the trading system 102 checks the average investment amount on each individual stock, the length or duration of investment (how long the user keeps the stock), under what market condition the user usually purchases a stock, under what market condition the user usually sells a stock, etc. The resulting strategies may be something similar to:
strategy 1—invests up to $10,000 and holds for minimum 1 year;
strategy 2—invests up to $5,000 and holds for short term;
strategy 3—do not invest;

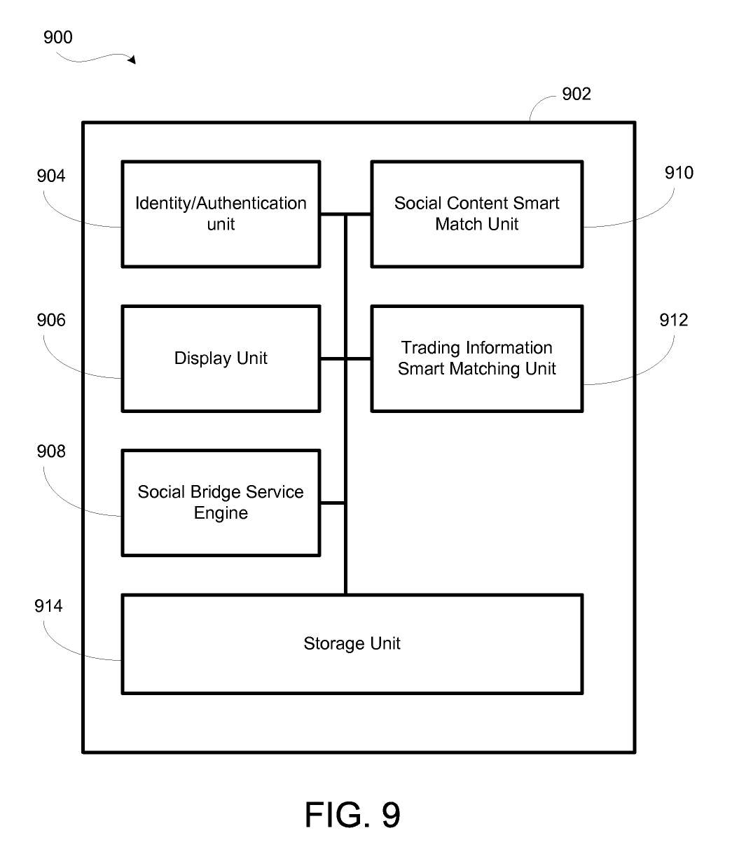

The trading system 102 of the present invention can be implemented on a single server or on a client-server configuration. FIG. 9 is a block diagram 900 of a server according to the present invention. The server 902 includes a user identity authentication unit 904, a display unit 906, a social bridge service engine 908, a storage unit 914, a social content smart matching unit 910, and a trading information smart matching unit 912. The user identity authentication unit 904 enables a user to log in by using a login and password for the trading system 102 or using user ID and a password for a social networking website. The identity authentication unit interfaces with social networking websites using a pre-established interface protocol to authenticate the user. The display unit 906 controls the display, whether the display device is local to the trading system 102 or remote. The social bridge service engine 908 provides interface between the social networking websites and the trading system 102. The social bridge service engine 908 enables information flow by using the pre-established interface protocol by each social networking interface. The social content smart matching unit 910 performs collection and indexing of postings from the social networking website as described above in FIG. 5. The trading information smart matching unit 912 performs searching, evaluation, and indexing of information posted on the trading system 102 as described above in FIG. 6. The trading information smart matching unit 912 will also calculate the credit score for each user by assigning scores to each posting and action, such as the actions listed in tables 1 and 2, taken by the user. The storage unit 914 stores postings (raw data), indexing information, user information, and control software for operating the trading system 102.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures and described in different embodiments can be easily combined within the scope of the invention.

Modifications, additions, or omissions may be made to the systems and methods described without departing from the scope of the disclosure. The components of the systems and methods described may be integrated or separated according to particular needs. Moreover, the operations of the systems and methods described may be performed by more, fewer, or other components without departing from the scope of the present disclosure.

Although the present disclosure has been described with several embodiments, sundry changes, substitutions, variations, alterations, and modifications can be suggested to one skilled in the art, and it is intended that the disclosure encompass all such changes, substitutions, variations, alterations, and modifications falling within the spirit and scope of the appended claims. It is also within the scope of the present invention that features described in different embodiments may be combined or interchanged.

What is claimed is:

1. A method, for rating the credibility of an online expert, comprising the steps of:
collecting, by a trading information smart matching unit, postings by the online expert on a trading system;
collecting, by the trading information smart matching unit, information related to the postings from public sources and social networking websites; and
calculating, by the trading information smart matching unit, a rating by comparing the information related to the postings with the postings.

2. The method of claim 1, wherein the information related to the posting includes information related to the online expert's own action, information related to actions from other users, accuracy of the online expert's past predictions, and information related to market condition.

3. A method, for providing financial information related to a stock to a user, comprising the steps of:
collecting, by a trading information smart matching unit on information posted by acquaintances of the user on at least social networking website, social-based information related to the stock;
assigning, by the trading information smart matching unit, a weight to each collected social-based information;
collecting, by the trading information smart matching unit on public sources, public information related to the stock;
assigning, by the trading information smart matching unit, a weight to each collected public information; and
presenting, by the trading information smart matching unit, hierarchically the collected social-based information and the collected public information to the user according to respective assigned weights.

4. The method of claim 3, the step of a weight to each collected social-based information further comprises the steps of:
identifying a source for the collected social-based information;
obtaining a credibility score for the source;
identifying a relationship between the source and the user;
identifying a timing information for the collected social-based information; and
calculating the weight for the collected social-based information according to the source, the relationship, and the timing information.

5. The method of claim 3, further comprising a steps for:
calculating a score based on weights assigned to the collected social-based information and to the collected public information; and
selecting an investment strategy according to the calculated score.

6. The method of claim 5, wherein the investment strategy is devised by considering the user's past investment history.

7. The method of claim 6, wherein the user's past investment history includes amount invested on each stock, a duration of each investment, and market condition when an investment is made.

8. A method, for calculating a credit score of a user by a trading system, comprising the steps of:
assigning, by a trading information smart matching unit, a first static score for each posting posted by the user;
assigning, by the trading information smart matching unit, a second static score for each positive feedback received by each posting posted by the user;
assigning, by the trading information smart matching unit, a negative score for each posting removed by the user;
assigning, by the trading information smart matching unit, a first variable score for each posting with a relevant subject matter posted by the user;
assigning, by the trading information smart matching unit, a second variable score for each posting posted timely by the user; and
determining the credit score by adding up scores assigned to the postings posted by the user.

9. The method of claim 8, further comprising the step of assigning, by the trading information smart matching unit, a third variable score for each posting, posted by the user, receiving a predetermined number of positive feedback.

10. The method of claim 8, wherein variable scores are changeable by the trading information smart matching unit according to information collected by the trading information smart matching unit from the trading system.

11. The method of claim 10, wherein a variable score assigned to a posting timely posted changes if the posting is posted with delay.
